(19) United States
(12) Patent Application Publication
(10) Pub. No.: US 2025/0290697 A1
(43) Pub. Date: Sep. 18, 2025

(54) HEAT CONDUCTIVE MEMBER AND HEAT EXCHANGER

(71) Applicant: NGK INSULATORS, LTD., Nagoya-City (JP)

(72) Inventors: Yutaro FUMOTO, Kasugai-City (JP); Tatsuya AKAHANI, Komaki-City (JP); Takeshi SAKUMA, Nagoya-City (JP)

(73) Assignee: NGK INSULATORS, LTD., Nagoya-City (JP)

(21) Appl. No.: 19/221,802

(22) Filed: May 29, 2025

Related U.S. Application Data
(62) Division of application No. 18/146,573, filed on Dec. 27, 2022.

(30) Foreign Application Priority Data
Mar. 15, 2022 (JP) 2022-040596

(51) Int. Cl. F28D 7/16; F28F 21/04

(52) U.S. Cl. CPC F28D 7/1615; F28F 21/04; F28F 2210/02

(57) ABSTRACT

A heat conductive member includes a honeycomb structure including: an outer peripheral wall; and a plurality of partition walls arranged on an inner side of the outer peripheral wall, the partition walls defining a plurality of cells, each of the cells extending from a first end face to a second end face to form a flow path for a first fluid. In a cross section of the honeycomb structure perpendicular to a flow path direction for the first fluid, the partition walls include a plurality of first partition walls extending in a radial direction and a plurality of second partition walls extending in a circumferential direction. At least a part of the first partition walls has a thickness of a portion that defines the cells closest to the outer peripheral wall larger than a thickness of a portion that defines the cells closest to a central portion.

### CROSS REFERENCE TO RELATED APPLICATIONS

This application is a division of U.S. application Ser. No. 18/146,573, filed Dec. 27, 2022, and claims the benefit of priority to Japanese Patent Application No 2022-040596 filed Mar. 15, 2022, the entireties of which are incorporated herein by reference.

### FIELD OF THE INVENTION

The present invention relates to a heat conductive member and a heat exchanger.

### BACKGROUND OF THE INVENTION

Recently, there is a need for improvement of fuel economy of motor vehicles. In particular, a system is expected that worms up a coolant, engine oil and an automatic transmission fluid (ATF: Automatic Transmission Fluid) at an early stage to reduce friction losses, in order to prevent deterioration of fuel economy at the time when an engine is cold, such as when the engine is started. Further, a system is expected that heats an exhaust gas purifying catalyst in order to activate the catalyst at an early stage.

As the above system, for example, there is a heat exchanger. The heat exchanger is a device that exchanges heat between a first fluid and a second fluid by allowing the first fluid to flow inside and the second fluid to flow outside. In such a heat exchanger, for example, the heat can be effectively utilized by exchanging the heat from the first fluid having a higher temperature (for example, an exhaust gas) to the second fluid having a lower temperature (for example, cooling water).

Known as a heat exchanger for recovering heat from the higher temperature gases such as exhaust gases from motor vehicles is a heat exchanger that uses a heat conductive member, also called a “heat exchange member”, which has a honeycomb structure including an outer peripheral wall, a first partition wall and a plurality of second partition walls arranged on an inner side of the outer peripheral wall, the first partition wall extending in a radial direction and the second partition walls extending in a circumferential direction in a cross section in an extending direction of cells (Patent Literatures 1 and 2). The heat exchanger can allow a first fluid to be circulated in the cells of the honeycomb structure and a second fluid to be circulated on the outer peripheral wall surface, thereby performing heat exchange.

### PRIOR ART

### Patent Literatures

[Patent Literature 1] WO 2019/135312 A1
[Patent Literature 2] Japanese Patent Application Publication No. 2019-120488 A

### SUMMARY OF THE INVENTION

The present invention is specified as follows:

The present invention relates to a heat conductive member, comprising
a honeycomb structure comprising: an outer peripheral wall; and a plurality of partition walls arranged on an inner side of the outer peripheral wall, the partition walls defining a plurality of cells, each of the cells extending from a first end face to a second end face to form a flow path for a first fluid,
wherein in a cross section of the honeycomb structure perpendicular to a flow path direction for the first fluid, the partition walls comprise a plurality of first partition walls extending in a radial direction and a plurality of second partition walls extending in a circumferential direction, and
wherein at least a part of the first partition walls has a thickness of a portion that defines the cells closest to the outer peripheral wall larger than a thickness of a portion that defines the cells closest to a central portion.

The present invention also relates to a heat conductive member, comprising
a honeycomb structure comprising: an outer peripheral wall; an inner peripheral wall; and partition walls arranged between the outer peripheral wall and the inner peripheral wall, the partition walls defining a plurality of cells, each of the cells extending from a first end face to a second end face to form a flow path for a first fluid,
wherein in a cross section of the honeycomb structure perpendicular to a flow path direction for the first fluid, the partition walls comprise a plurality of first partition walls extending in a radial direction and a plurality of second partition walls extending in a circumferential direction, and
wherein the number of the cells closest to the outer peripheral wall in the circumferential direction is larger than that of the cells closest to the inner peripheral wall in the circumferential direction.

The present invention also relates to a heat exchanger, comprising:
the heat conductive member; and
an outer cylinder arranged at an interval on a radially outer side of the covering member so that a second fluid can circulate over an outer periphery of the covering member.

### BRIEF DESCRIPTION OF THE DRAWINGS

FIG. 1 is a cross-sectional view of a heat conductive member according to Embodiment 1 of the present invention, which is parallel to an axial direction of a honeycomb structure;

FIG. 2 is a cross-sectional view taken along the line a-a′ in the heat conductive member shown in FIG. 1;

FIG. 3 is a cross-sectional view of a heat conductive member in another aspect according to Embodiment 1 of the present invention, which is perpendicular to an axial direction of a honeycomb structure;

FIG. 4 is a cross-sectional view of a heat conductive member in another aspect according to Embodiment 1 of the present invention, which is perpendicular to an axial direction of a honeycomb structure;

FIG. 5 is a cross-sectional view of a heat conductive member in another aspect according to Embodiment 1 of the present invention, which is perpendicular to an axial direction of the honeycomb structure;

FIG. 6 is a cross-sectional view of a heat conductive member in another aspect according to Embodiment 1 of the present invention, which is perpendicular to an axial direction of a honeycomb structure;

FIG. 7 is a cross-sectional view of a heat conductive member in another aspect according to Embodiment 1 of the present invention, which is perpendicular to an axial direction of a honeycomb structure;

FIG. 8 is a cross-sectional view of a heat exchanger according to Embodiment 1 of the present invention, which is parallel to an axial direction of a honeycomb structure;

FIG. 9 is a cross-sectional view taken along the line b-b′ in the heat exchanger shown in FIG. 8;

FIG. 10 is a cross-sectional view of a heat conductive member according to Embodiment 2 of the present invention, which is parallel to an axial direction of a honeycomb structure;

FIG. 11 is a cross-sectional view taken along the line c-c′ in the heat conductive member shown in FIG. 10;

FIG. 12 is a cross-sectional view of a heat conductive member in another aspect according to Embodiment 2 of the present invention, which is perpendicular to an axial direction of a honeycomb structure;

FIG. 13 is a cross-sectional view of a heat conductive member in another aspect according to Embodiment 2 of the present invention, which is perpendicular to an axial direction of a honeycomb structure;

FIG. 14 is a partially enlarged cross-sectional view of a honeycomb structure produced in Example 1, which is perpendicular to an axial direction;

FIG. 15 is a partially enlarged cross-sectional view of a honeycomb structure produced in Example 2, which is perpendicular to an axial direction; and

FIG. 16 is a partially enlarged cross-sectional view of a honeycomb structure produced in Comparative Example 1, which is perpendicular to an axial direction.

### DETAILED DESCRIPTION OF THE INVENTION

In the conventional honeycomb structures including the first partition wall extending in the radial direction and the plurality of second partition walls extending in the circumferential direction, a cell width on the outer peripheral wall side was larger than that on the central portion side, so that heat recovery could not sufficiently be performed in the cells on the outer peripheral wall side.

The present invention has been made to solve the above problems. An object of the present invention is to provide a heat conductive member and a heat exchanger which can improve a heat recovery efficiency.

The above problems are solved by the present invention set forth below.

According to the present invention, it is possible to provide a heat conductive member and a heat exchanger which can improve a heat recovery efficiency.

Hereinafter, embodiments of the present invention will be specifically described with reference to the drawings. It is to understand that the present invention is not limited to the following embodiments, and those which appropriately added changes, improvements and the like to the following embodiments based on knowledge of a person skilled in the art without departing from the spirit of the present invention fall within the scope of the present invention.

### Embodiment 1

### (1) Heat Conductive Member

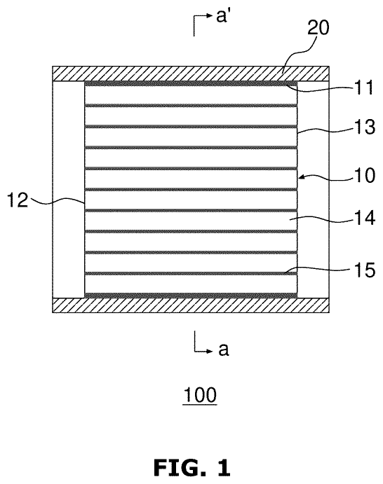

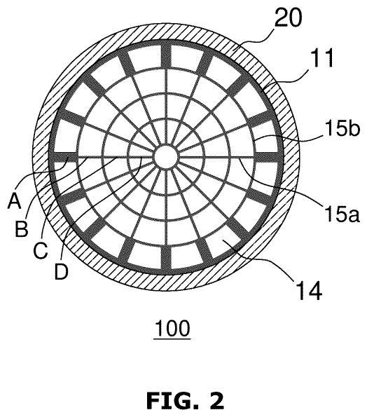

FIG. 1 is a cross-sectional view of a heat exchange member according to Embodiment 1 of the present invention, which is parallel to an axial direction (a flow path direction of a first fluid) of a honeycomb structure. FIG. 2 is a cross-sectional view taken along the line a-a′ in the heat conductive member shown in FIG. 1, that is, a cross sectional view of the heat conductive member according to Embodiment 1 of the present invention, which is perpendicular to the axial direction of the honeycomb structure.

A heat conductive member 100 according to Embodiment 1 of the present invention includes: a honeycomb structure 10 including: an outer peripheral wall 11; and partition walls 15 arranged on an inner side of the outer peripheral wall 11, the partition walls 15 defining a plurality of cells 14 each extending from a first end face 12 to a second end face 13 to form a flow path for a first fluid. Also, the heat conductive member 100 can optionally include a covering member 20 that covers an outer peripheral surface of the outer peripheral wall 11.

In the heat conductive member 100 having such a structure, heat exchange between the first fluid that can flow though the cells 14 and a second fluid that can flow over an outer periphery of the outer peripheral wall 11 is performed via the outer peripheral wall 11 of the honeycomb structure 10. Also, when the heat conductive member 100 includes the covering member 20, the heat exchange between the first fluid that can flow though the cells 14 and the second fluid that can flow over an outer periphery of the outer peripheral wall 11 is performed via the outer peripheral wall 11 and the covering member 20.

It should be noted that in FIG. 1, the first fluid can flow in both right and left directions on a page surface of FIG. 1. The first fluid is not particularly limited, and various liquids or gases may be used. For example, when the heat conductive member 100 is used for a heat exchanger mounted on a motor vehicle, the first fluid is preferably an exhaust gas.

The partition walls 15 forming the honeycomb structure 10 have a plurality of first partition walls 15a extending in a radial direction and a plurality of second cells 15b extending in a circumferential direction, in a cross section of the honeycomb structure 10 perpendicular to a flow path direction of the first fluid (that is, the cross section as shown in FIG. 2). The partition walls 15 (in particular the partition walls 15a) having such a structure can allow the heat of the first fluid to be transferred in the radial direction through the partition walls 15a, so that the heat of the first fluid can be efficiently transferred to the outside of the honeycomb structure 10.

At least a part of the first partition walls 15a has a thickness of a portion that defines the cells 14 closest to the outer peripheral wall 11 larger than a thickness of a portion that defines the cells 14 closest to a central portion. For example, in the honeycomb structure 10 as shown in FIG. 2, the thickness of a portion A that defines the cells 14 closest to the outer peripheral wall 11 is larger than that of a portion D that defines the cells 14 closest to the central portion. Such a structure of the first partition walls 15a can reduce a difference between a cell width on the central portion side and a cell width on the outer peripheral wall 11 side. As a result, the cells 14 on the outer peripheral wall 11 side can also perform heat recovery to the same extent as that of the cells 14 on the central portion side, so that a heat recovery efficiency of the honeycomb structure 10 can be improved as a whole. Further, since the thickness of the portion that defines the cells 14 closest to the outer peripheral wall 11 is larger, the honeycomb structure 10 can be prevented from being destructed (e.g., cracked, braked and the like) due to external impact, thermal stress caused by a temperature difference between the first fluid and the second fluid, and the like.

As used herein, the “cell width” means a linear length at the central portion in the radial direction between the two first partition walls 15a that form one cell 14 (that is, a linear length connecting the radial central portions of the two first partition walls 15a that form one cell 14).

It should be noted that although FIG. 2 shows an example where for all of the first partition walls 15a, the thickness of the portion A that defines the cells 14 closest to the outer peripheral wall 11 is larger than that of the portion D that defines the cells 14 closest to the central portion, a part of the first partition walls 15a may have the same thickness from the central portion to the outer peripheral wall 11.

At least a part of the first partition walls 15a may have three or more portions that define three or more cells 14 in the radial direction, and may have the thickness of the portions that define the cells 14 located on the outer peripheral wall 11 side equal to or larger than that of the portions that define the cells 14 located on the central portion side. For example, the honeycomb structure 10 as shown in FIG. 2 has four portions A to D that define four cells 14 in the radial direction, and the thickness of the portion A is larger than that of each of the portions B to D, and the portions B to D have the same thickness. Such structures of the first partition walls 15a can easily reduce a difference between the cell width on the central portion side and the cell width on the outer peripheral wall 11 side, so that the heat recovery efficiency can be improved.

It should be noted that although FIG. 2 shows an example where the portions B to D have the same thickness, the portions BD may have different thicknesses. For example, the thickness of the portion B can be larger than the thickness of portions C and D, and the thickness of portion C can be larger than the thickness of portion D.

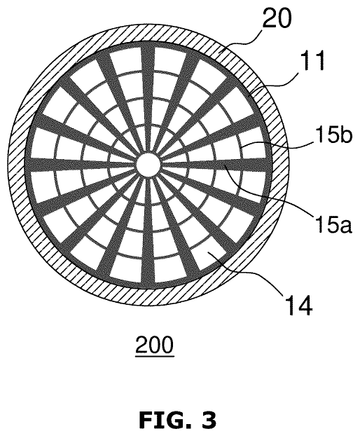

The thickness of the first partition walls 15a may gradually increase from the central portion to the outer peripheral wall 11. FIG. 3 shows a cross-sectional view of the heat conductive member having such a structure, which is perpendicular to the axial direction of the honeycomb structure. The heat conductive member 200 including the honeycomb structure 10 having the first partition walls 15a having such a structure can also easily reduce the difference between the cell width on the central portion side and the cell width on the outer peripheral wall 11 side, so that the heat recovery efficiency in the cells 14 on the outer peripheral wall 11 side can be improved.

It should be noted that although FIG. 3 shows an example where the thicknesses of all the first partition walls 15a gradually increase from the central portion to the outer peripheral wall 11, the thickness of a part of the first partition walls 15a may gradually increase from the central portion to the outer peripheral wall 11.

The first partition walls 15a may linearly extend from the central portion to the outer peripheral wall 11, as shown in FIGS. 2 and 3. The first partition walls 15a having such a structure provides linear heat transfer paths of the first partition walls 15a, so that the heat of the first fluid can be efficiently transferred to the outside of the honeycomb structure 10. On the other hand, if the first partition walls 15a do not linearly extend from the central portion to the outer peripheral wall 11, the heat transfer paths of the first partition walls 15a are curved (heat transfer is required via the second partition walls 15b), so that it will be difficult to efficiently transmit the heat of the first fluid to the outside of the honeycomb structure 10.

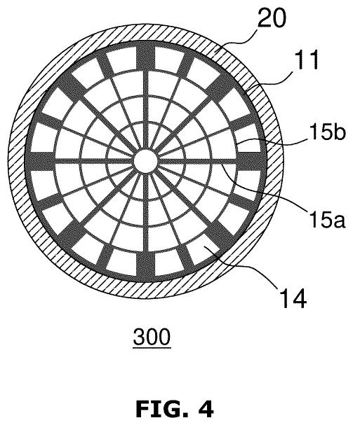

The partition walls 15 may include first partitions 15a having different thicknesses at adjacent portions in the circumferential direction. FIG. 4 shows a cross-sectional view of the heat conductive member having such a structure, which is perpendicular to the axial direction of the honeycomb structure. The heat conductive member 300 including the honeycomb structure 10 having the first partition walls 15a having such a structure can also easily reduce the difference between the cell width on the central portion side and the cell width on the outer peripheral wall 11 side, so that the heat recovery efficiency in the cells 14 on the outer peripheral wall 11 side can be improved.

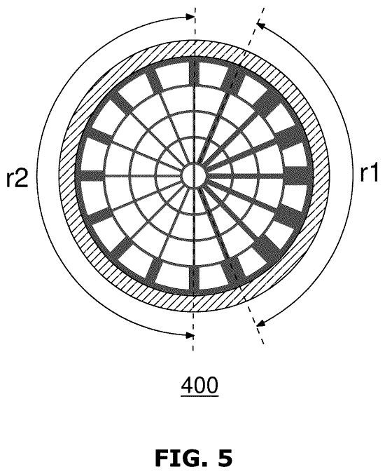

The honeycomb structure 10 may have two or more regions including the first partition walls 15a with different thicknesses in the circumferential direction. FIG. 5 shows a cross-sectional view of the heat conductive member having such a structure, which is perpendicular to the axial direction of the honeycomb structure. The honeycomb structure 10 in the heat conductive member 400 as shown in FIG. 5 has two regions r1 and r2 including the first partition walls 15a with different thicknesses in the circumferential direction. In an actual heat exchanger, there are a portion where the heat of the first fluid is easily recovered and a portion where the heat of the first fluid is difficult to be recovered in the circumferential direction of the honeycomb structure, depending on a position of a feed port or a discharge port of the second fluid flowing around the outer circumference of the outer peripheral wall 11 (or the covering member 20 if present). Therefore, the region r1 including the first partition walls 15a with a larger thickness is provided at the portion where the heat of the first fluid is easily recovered, and the region r2 including the first partition walls 15a with a smaller thickness is provided at the portion where the heat of the first fluid is difficult to be recovered, whereby the heat of the first fluid can be efficiently recovered.

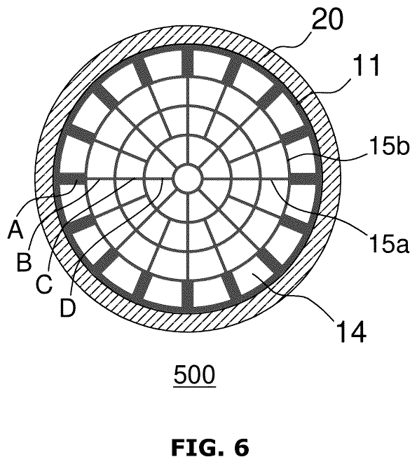

In the honeycomb structure 10, among the cells 14 defined by the first partition walls 15a, the number of the cells 14 closest to the outer peripheral wall 11 in the circumferential direction may be larger than that of the cells 14 closest to the central portion in the circumferential direction. FIG. 6 shows a cross-sectional view of the heat conductive member having such a structure, which is perpendicular to the axial direction of the honeycomb structure. In the honeycomb structure 10 in the heat conductive member 500 as shown in FIG. 6, among the cells 14 defined by the first partition walls 15a, the number of the cells 14 closest to the central portion in the circumferential direction is 16, whereas the number of the cells 14 closest to the central portion in the circumferential direction is 8. The control of the number of cells 14 in the circumferential direction in this manner can easily reduce the difference between the cell width on the central portion side and the cell width on the outer peripheral wall 11 side, so that the heat recovery efficiency in the cells 14 on the outer peripheral wall side can be improved.

At least a part of the first partition walls 15a may have three or more portions that define three or more cells 14 in the radial direction, and the number of the cells 14 located on the outer peripheral wall 11 side in the circumferential direction may be equal to or larger than the number of the cells 14 located on the central portion side in the circumferential direction. For example, in the honeycomb structure 10 as shown in FIG. 6, the first partition walls 15a have four portions A to D that define four cells 14 in the radial direction, and the number of the cells 14 defined by the partition walls 15 including the portion A in the circumferential direction is the same as the number of the cells 14 defined by the partition walls 15 including the portion B or C in the circumferential direction, and larger than the number of the cells 14 defined by the partition walls 15 including the portion D. Also, the number of the cells 14 defined by the partition walls 15 including the portion B in the circumferential direction is the same as the number of the cells 14 defined by the partition walls 15 including the portion C in the circumferential direction, and larger than the number of the cells 14 defined by the partition walls 15 including the portion D in the circumferential direction. Furthermore, the number of the cells 14 defined by the partition walls 15 including portion C in the circumferential direction is larger than the number of the cells 14 defined by the partition walls 15 including portion D in the circumferential direction. The control of the number of the cells 14 in the circumferential direction in this manner can easily reduce the difference between the cell width on the central portion side and the cell width on the outer peripheral wall 11 side, so that the heat recovery efficiency in the cells 14 on the outer peripheral wall 11 side can be improved.

The cells 14 defined by the first partition walls 15a and the second partition walls 15b preferably have substantially the same cell width in the circumferential direction. Such a structure provides the same flow path resistance in the circumferential direction, so that the first fluid can be uniformly circulated in the circumferential direction.

The honeycomb structure 10 may have a shape (outer shape) such as a cylinder, an elliptical pillar shape, a quadrangular pillar shape, or other polygonal pillar shapes, although not particularly limited thereto. It should be noted that FIGS. 1 to 6 show an example where the honeycomb structure 10 has a cylindrical shape (outer shape).

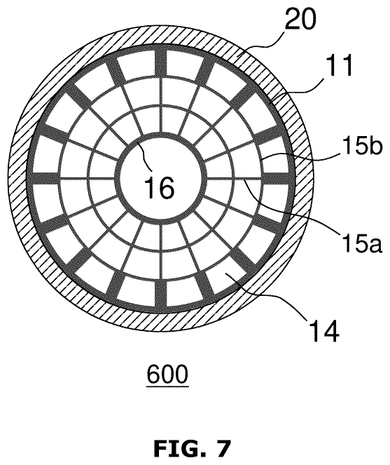

The honeycomb structure 10 is not limited to the solid honeycomb structure as shown in FIGS. 1 to 6, and it may be a hollow type honeycomb structure having a central hollow region into which a cylindrical member can be inserted. FIG. 7 shows a cross-sectional view of a heat conductive member having such a structure, which is perpendicular to the axial direction of the honeycomb structure. The honeycomb structure 10 in the heat conductive member 600 as shown in FIG. 7 further includes an inner peripheral wall 16, and has the partition walls 15 (first partition wall 15a and second partition wall 15b) arranged between the outer peripheral wall 11 and the inner peripheral wall 16. Such a hollow type honeycomb structure can also provide the same effects as those of the solid honeycomb structure.

It should be noted that in the hollow type honeycomb structure, the outer shape and the shape of the hollow region may be the same or different, but they are preferably the same, in terms of resistance to external impact, thermal stress or the like.

The thickness of each of the outer peripheral wall 11 (the outer peripheral wall 11 and the inner peripheral wall 16 in the case of the hollow type honeycomb structure) and the partition walls 15 (the first partition walls 15a and the second partition walls 15b) can be appropriately adjusted depending on the applications.

The thickness of the outer peripheral wall 11 (for the hollow type honeycomb structure, the outer peripheral wall 11 and the inner peripheral wall 16) is preferably larger than that of the partition walls 15a. Such a structure can lead to increased strength of the outer peripheral wall 11 (for the hollow type honeycomb structure, the outer peripheral wall 11 and the inner peripheral wall 16) which would otherwise tend to generate destruction (e.g., cracking, breakage, and the like) due to external impact, thermal stress caused by a temperature difference between the first fluid and the second fluid, and the like.

When using the heat conductive member 100, 200, 300, 400, 500, 600 for general heat exchange applications, the thickness of the outer peripheral wall 11 and the inner peripheral wall 16 is preferably more than 0.3 mm and 10 mm or less, and more preferably from 0.5 mm to 5 mm, and even more preferably from 1 mm to 3 mm. Moreover, when using the heat conductive member 100, 200, 300, 400, 500, 600 for a thermal storage application, the thickness of the outer peripheral wall 11 is preferably 10 mm or more, in order to increase a heat capacity of the outer peripheral wall 11.

For the first partition walls 15a, the thickness of the portion that defines the cells 14 closest to the outer peripheral wall 11 may preferably be 0.05 to 1 mm, and more preferably 0.1 to 0.8 mm, and even more preferably 0.2 to 0.6 mm. Further, for the first partition walls 15a, the thickness of the portion that defines the cells 14 closest to the central portion is 0.02 to 0.9 mm, and more preferably 0.05 to 0.7 mm, and even more preferably 0.1 to 0.5 mm.

The thickness of the second partition walls 15b may preferably be 0.1 to 1 mm, and more preferably 0.2 to 0.6 mm. The thickness of the second partition walls 15b of 0.1 mm or more can provide the honeycomb structure 10 with a sufficient mechanical strength. Further, the thickness of the second partition walls 15b of 1 mm or less can suppress problems that the pressure loss is increased due to a decrease in an opening area and the heat recovery efficiency is decreased due to a decrease in a contact area with the first fluid.

The outer peripheral wall 11 (for the hollow type honeycomb structure, the outer peripheral wall 11 and the inner peripheral wall 16) is based on ceramics. The phrase “based on ceramics” means that a ratio of a mass of ceramics to the total mass is 50% by mass or more.

Each of the outer peripheral wall 11 (for the hollow type honeycomb structure, the outer peripheral wall 11 and the inner peripheral wall 16) and the partition walls 15 preferably has a porosity of 10% or less, and more preferably 5% or less, and even more preferably 3% or less. Further, the porosity of the outer peripheral wall 11, the inner peripheral wall 16 and the partition walls 15 may be 0%. The porosity of the outer peripheral wall 11, the inner peripheral wall 16 and the partition walls 15 of 10% or less can lead to improvement of thermal conductivity.

The outer peripheral wall 11 (for the hollow type honeycomb structure, the outer peripheral wall 11 and the inner peripheral wall 16) and the partition walls 15 are preferably based on SiC (silicon carbide) having high thermal conductivity. The phrase “based on SiC (silicon carbide)” means that a ratio of a mass of SiC (silicon carbide) to the total mass is 50% by mass or more.

More particularly, the material of each of the outer peripheral wall 11, the inner peripheral wall 16 and the partition walls 15 that can be used herein includes Si—SiC materials such as Si-impregnated SiC and (Si+Al) impregnated SiC, metal composite SiC, recrystallized SiC, Si₃N₄, SiC, and the like. Among them, the Si—SiC material is preferably used, because it can be produced at a lower cost, and has high thermal conductivity.

A cell density (that is, the number of cells 14 per unit area) in the cross section of the honeycomb structure 10 perpendicular to the axial direction is not particularly limited. The cell density may be adjusted as needed, and preferably in a range of from 4 to 320 cells/cm². The cell density of 4 cells/cm² or more can sufficiently ensure the strength of the partition walls 15, hence the strength of the honeycomb structure 10 itself and effective GSA (geometrical surface area). Further, the cell density of 320 cells/cm² or less can allow an increase in a pressure loss to be prevented when the first fluid flows.

The honeycomb structure 10 preferably has an isostatic strength of more than 100 MPa or more, and more preferably 200 MPa or more. The isostatic strength of the honeycomb structure 10 of more than 100 MPa or more can lead to the honeycomb structure 10 having improved durability. The isostatic strength of the honeycomb structure 10 can be measured according to the method for measuring isostatic breakdown strength as defied in the JASO standard M 505-87 which is a motor vehicle standard issued by Society of Automotive Engineers of Japan, Inc.

A diameter (outer diameter) of the outer peripheral wall 11 in the cross section perpendicular to the axial direction of the honeycomb structure 10 may preferably be from 20 to 200 mm, and more preferably from 30 to 100 mm. Such a diameter can allow improvement of heat recovery efficiency. If the outer peripheral wall 11 is not circular, the diameter of the largest inscribed circle inscribed in the cross-sectional shape of the outer peripheral wall 11 is defined as the diameter of the outer peripheral wall 11.

Further, when the honeycomb structure 10 is the hollow type honeycomb structure, a diameter of the inner peripheral wall 16 in the cross section perpendicular to the axial direction of the honeycomb structure 10 is preferably from 1 to 50 mm, and more preferably from 2 to 30 mm. If the cross-sectional shape of the inner peripheral wall 16 is not circular, the diameter of the largest inscribed circle inscribed in the cross-sectional shape of the inner peripheral wall 16 is defined as the diameter of the inner peripheral wall 16.

The honeycomb structure 10 preferably has a thermal conductivity of 50 W/(m·K) or more at 25° C., and more preferably from 100 to 300 W/(m·K), and even more preferably from 120 to 300 W/(m K). The thermal conductivity of the honeycomb structure 10 in such a range can lead to an improved thermal conductivity and can allow the heat inside the honeycomb structure 10 to be efficiently transmitted to the outside. It should be noted that the value of thermal conductivity is a value measured according to the laser flash method (JIS R 1611:1997).

In the case where an exhaust gas as the first fluid flows through the cells 14 in the honeycomb structure 10, a catalyst may preferably be supported on the partition walls 15 of the honeycomb structure 10. The supporting of the catalyst on the partition walls 15 can allow CO, NOx, HC and the like in the exhaust gas to be converted into harmless substances through catalytic reaction, and can also allow reaction heat generated during the catalytic reaction to be utilized for heat exchange. Preferable catalysts include those containing at least one element selected from the group consisting of noble metals (platinum, rhodium, palladium, ruthenium, indium, silver and gold), aluminum, nickel, zirconium, titanium, cerium, cobalt, manganese, zinc, copper, tin, iron, niobium, magnesium, lanthanum, samarium, bismuth, and barium. Any of the above-listed elements may be contained as a metal simple substance, a metal oxide, or other metal compound.

A supported amount of the catalyst (catalyst metal+support) may preferably be from 10 to 400 g/L. Further, when using the catalyst containing the noble metal(s), the supported amount may preferably be from 0.1 to 5 g/L. The supported amount of the catalyst (catalyst metal+support) of 10 g/L or more can easily achieve catalysis. On the other hand, the supported amount of 400 g/L or less can suppress increases in manufacturing cost and pressure loss. The support refers to a carrier on which the catalyst metal is supported. Examples of the supports include those containing at least one selected from the group consisting of alumina, ceria and zirconia.

The covering member 20 is not particularly limited as long as it can cover the outer peripheral surface of the outer peripheral wall 11 of the honeycomb structure 10. For example, it is possible to use a cylindrical member that is fitted into the outer peripheral surface of the outer peripheral wall 11 of the honeycomb structure 10 to cover circumferentially the outer peripheral wall 11 of the honeycomb structure 10. From the viewpoint of buffering, an inorganic mat or other material may be interposed between the honeycomb structure 10 and the covering member 20.

As used herein, the “fitted” means that the honeycomb structure 10 and the covering member 20 are fixed in a state of being suited to each other. Therefore, the fitting of the honeycomb structure 10 and the covering member 20 encompasses cases where the honeycomb structure 10 and the covering member 20 are fixed to each other by a fixing method based on fitting such as clearance fitting, interference fitting and shrinkage fitting, as well as by brazing, welding, diffusion bonding, or the like.

The covering member 20 can have an inner surface shape corresponding to the outer peripheral wall 11 of the honeycomb structure 10. Since the inner surface of the covering member 20 is in direct contact with the outer peripheral wall 11 of the honeycomb structure 10, the thermal conductivity is improved and the heat in the honeycomb structure 10 can be efficiently transferred to the covering member 20.

In terms of improvement of the heat recovery efficiency, a higher ratio of an area of a portion circumferentially covered with the covering member 20 in the outer peripheral wall 11 of the honeycomb structure 10 to the total area of the outer peripheral wall 11 of the honeycomb structure 10 is preferable. Specifically, the area ratio is preferably 80% or more, and more preferably 90% or more, and even more preferably 100% (that is, the entire outer peripheral surface of the outer peripheral wall 11 of the honeycomb structure 10 is circumferentially covered with the covering member 20).

It should be noted that the term “outer peripheral wall 11” as used herein refers to a surface of the honeycomb structure 10, parallel to the axial direction of the honeycomb structure 10, and does not include surfaces (the first end face 12 and the second end face 13) of the honeycomb structure 10, which are perpendicular to the axial direction of the honeycomb structure 10.

The covering member 20 is preferably made of a metal in terms of manufacturability. Further, the metallic covering member 20 is also preferable in that it can be easily welded to an outer cylinder (casing) 30 that will be described below. Examples of the material of the covering member 20 that can be used herein include stainless steel, titanium alloys, copper alloys, aluminum alloys, brass and the like. Among them, the stainless steel is preferable because it has high durability and reliability and is inexpensive.

The covering member 20 preferably has a thickness of 0.1 mm or more, and more preferably 0.3 mm or more, and still more preferably 0.5 mm or more, for the reason of durability and reliability. The thickness of the covering member 20 is preferably 10 mm or less, and more preferably 5 mm or less, and still more preferably 3 mm or less, for the reason of reducing thermal resistance and improving thermal conductivity.

A length of the covering member 20 (a length in the flow path direction for the first fluid) is not particularly limited, and it may be adjusted as needed depending on the size of the honeycomb structure 10 or the like. For example, the length of the covering member 20 is preferably larger than the length of the honeycomb structure 10. Specifically, the length of the covering member 20 is preferably from 5 mm to 250 mm, and more preferably from 10 mm to 150 mm, and still more preferably from 20 mm to 100 mm.

It should be noted that when the length of the covering member 20 is larger than the length of the honeycomb structure 10, the covering member 20 is preferably provided such that the honeycomb structure 10 is positioned at the central portion of the covering member 20.

Next, methods for producing the heat conductive member 100, 200, 300, 400, 500, 600 will be described. However, the methods for producing the heat conductive member 100, 200, 300, 400, 500, 600 are not limited to those described below.

First, a green body containing ceramic powder is extruded into a desired shape to prepare a honeycomb formed body. At this time, the shape and density of the cells 14, the number, lengths and thicknesses of the partition walls 15 (the first partition walls 15a and the second partition walls 15b), the shapes and the thicknesses of the outer peripheral wall 11 and the inner peripheral wall 16, and the like, can be controlled by selecting dies and jig in appropriate forms. The material of the honeycomb formed body that can be used herein includes the ceramics as described above. For example, when producing a honeycomb formed body based on a Si-impregnated SiC composite, a binder and water or an organic solvent are added to a predetermined amount of SiC powder, and the resulting mixture is kneaded to form a green body, which is formed into a honeycomb formed body having a desired shape. The resulting honeycomb formed body can be then dried, and the honeycomb formed body can be impregnated with metallic Si and fired under reduced pressure in an inert gas or vacuum to obtain the honeycomb structure 10.

The honeycomb structure 10 is then shrinkage-fitted into the covering member 20, whereby the outer peripheral surface of the outer peripheral wall 11 of the honeycomb structure 10 is circumferentially covered with the covering member 20. Specifically, the honeycomb structure 10 can be fixed into the covering member 20 by heating and expanding the covering material 20, inserting the honeycomb structure 10 into the covering member 20, and then cooling and shrinking the covering member 20. As described above, the fitting of the honeycomb structure 10 and the covering member 20 can be performed by, in addition to the shrinkage fitting, a fixing method based on fitting such as clearance fitting and interference fitting, or by brazing, welding, diffusion bonding or the like. Thus, the heat conductive member 10 can be obtained.

The heat conductive member 100, 200, 300, 400, 500, 600 according to Embodiment 1 of the present invention includes the honeycomb structure 10 having the partition walls 15a in which the thickness of the portion that defines the cells 14 closest to the outer peripheral wall 11 is larger than that of the portion that defines the cells 14 closest to the central portion, so that the difference between the cell width on the central portion side and the cell width on the outer peripheral wall 11 side is smaller, and in the cells 14 on the outer peripheral wall 11 side, the heat recovery can be performed to the same extent as the cells 14 on the central portion side.

### (2) Heat Exchanger

The heat exchanger according to Embodiment 1 of the present invention includes the heat conductive member 100, 200, 300, 400, 500, 600 as described above. A member(s) other than the heat conductive member 100, 200, 300, 400, 500, 600 is/are not particularly limited, and a known member(s) may be used. For example, the heat exchanger according to Embodiment 1 of the present invention may include: the heat conductive member 100, 200, 300, 400, 500, 600; and an outer cylinder (casing) at an interval on a radially outer side of the covering member 20 such that a second fluid can flow on the outer periphery of the covering member 20.

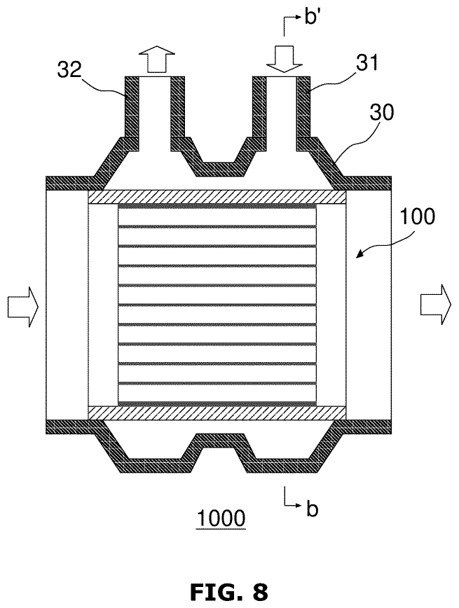

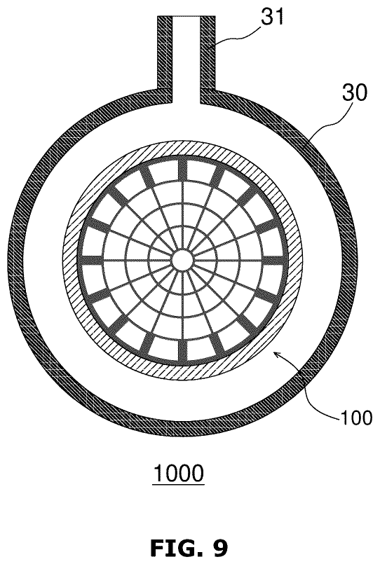

FIG. 8 is a cross-sectional view of a heat exchanger according to Embodiment 1 of the present invention, which is parallel to an axial direction of a honeycomb structure. Also, FIG. 9 is a cross-sectional view taken along the line b-b′ in the heat exchanger shown in FIG. 8, which is a cross-sectional view of the heat exchanger according to Embodiment 1 of the present invention, which is perpendicular to the axial direction of the honeycomb structure.

A heat exchanger 1000 according to Embodiment 1 of the present invention includes the heat conductive member 100; and an outer cylinder 30 arranged at an interval on the radially outer side of the covering member 20 such that the second fluid can flow on the outer periphery of the covering member 20 of the heat conductive member 100. The outer cylinder 30 has a feed pipe 31 and a discharge pipe 32 for the second fluid. It is preferable that the outer cylinder 30 circumferentially covers the entire outer periphery of the heat conductive member 100.

In the heat exchanger 1000 having the above structure, the second fluid flows into the outer cylinder 30 through the feed pipe 31. Then, while passing through the flow path for the second fluid, the second fluid undergoes heat exchange with the first fluid flowing through the cells 14 of the honeycomb structure 10 via the covering member 20 of the heat conductive member 100, and then flows out from the discharge pipe 32 for the second fluid. It should be noted that the outer peripheral surface of the covering member 20 of the heat conductive member 100 may be covered with a member for adjusting a heat transfer efficiency.

The second fluid is not particularly limited, but the second fluid is preferably water or an anti-freezing solution (LLC defined in JIS K 2234: 2006) when the heat exchanger 1000 is mounted on a motor vehicle. For the temperatures of the first fluid and the second fluid, the temperature of the first fluid is preferably higher than that of the second fluid, because under the temperature condition, the covering member 20 of the heat conductive member 100 does not expand at the lower temperature and the honeycomb structure 10 expands at the higher temperature, so that the two fitted members is difficult to be loosened. In particular, when the fitting of the honeycomb structure 10 and the covering member 20 is shrinkage fitting, the above temperature condition can minimize a risk that the fitted members are loosened and the honeycomb structure 10 is fallen out.

Preferably, an inner surface of the outer cylinder 30 is fitted into the outer peripheral surface of the covering member 20 of the heat conductive member 100. This can result in a structure in which the outer peripheral surface of the covering member 20 at both end portions in the flow path direction for the first fluid is circumferentially brought into close contact with the inner surface of the outer cylinder 30, so as to prevent the second fluid from leaking to the outside. A method for bringing the outer peripheral surface of the covering member 20 into close contact with the inner surface of the outer cylinder 30 includes, but not limited to, welding, diffusion bonding, brazing, mechanical fastening, and the like. Among them, the welding is preferable because it has higher durability and reliability and can improve structural strength.

The outer cylinder 30 is preferably made of a metal in terms of thermal conductivity and manufacturability. Examples of the metal that can be used herein include stainless steel, titanium alloys, copper alloys, aluminum alloys, brass, and the like. Among them, the stainless steel is preferable because it is inexpensive and has high durability and reliability.

The outer cylinder 30 preferably has a thickness of 0.1 mm or more, and more preferably 0.5 mm or more, and still more preferably 1 mm or more, for the reasons of durability and reliability. The thickness of the outer cylinder 30 is preferably 10 mm or less, and more preferably 5 mm or less, and still more preferably 3 mm or less, in terms of cost, volume, weight and the like.

The outer cylinder 30 may be an integrally formed product, but it may preferably be a joined member formed of two or more members. In the case where the outer cylinder 30 is the joined member formed of two or more members, freedom in design for the outer cylinder 30 can be improved.

The positions of the feed pipe 31 and the discharge pipe 22 for the second fluid are not particularly limited. The positions may be changed as needed to the axial direction and the outer peripheral direction, in view of the installation position of the heat exchanger 1000, the piping position, and the heat exchange efficiency. For example, the feed pipe 31 and the discharge pipe 32 for the second fluid can be provided at positions corresponding to the axial ends of the honeycomb structure 10. The feed pipe 31 and the discharge pipe 32 for the second fluid may extend toward the same direction or toward different directions.

Although FIGS. 8 and 9 show the case of using the heat conductive member 100, the heat conductive members 200, 300, 400, 500, and 600 may be used in place of the heat conductive member 100.

When the heat conductive member 600 is used, it can further include an inner cylinder in a hollow region of the honeycomb structure 10 (on the inner peripheral side of the inner peripheral wall 16) and an on-off valve provided in the inner cylinder.

The inner cylinder can have through holes for introducing the first fluid into the cells 14 of the honeycomb structure 10, and the through holes can branch the flow of the first fluid into two flows (into the cells 14 and the hollow portion of the honeycomb structure 10).

The on-off valve can control an amount of the first fluid flowing through the hollow region of the honeycomb structure 10 by its opening/closing mechanism. In particular, the on-off valve can selectively introduce the first fluid into the cells 14 of the honeycomb structure 10 through the through holes by blocking the flow of the first fluid inside the inner cylinder during heat exchange between the first fluid and the second fluid.

The through holes provided in the inner cylinder may be formed around the entire circumference of the inner cylinder or at a partial position (e.g., only at the upper, center or lower position) of the inner cylinder. The through holes may have various shapes, such as circular, oval, and quadrangular shapes.

In the heat exchanger 1000 having such a structure, the first fluid can be circulated inside the inner cylinder. When the on-off valve is closed, the ventilation resistance inside the inner cylinder increases, and the first fluid selectively flows into the cells 14 through the through holes. On the other hand, when the on-off valve is open, the ventilation resistance inside the inner cylinder decreases, and the first fluid selectively flows into the inner cylinder inside the hollow region. Therefore, the controlling of the opening and closing of the on-off valve can adjust the amount of the first fluid flowing into the cells 14. Since the first fluid flowing through the inner cylinder in the hollow region hardly contributes to the heat exchange with the second fluid, this flow path for the first fluid functions as a bypass route in a case where the heat recovery of the first fluid is desired to be suppressed. In other words, if it is desired to suppress the heat recovery of the first fluid, the on-off valve may be opened.

Next, the method for producing the heat exchanger 1000 will be described. However, the method for producing the heat exchanger 1000 is not limited to the production method as described below.

The heat exchanger 1000 can be producing by arranging the outer cylinder 30 at an interval on the radially outer side of the covering member 20 of the heat conductive member 100, 200, 300, 400, 500, 600 and joining them such that the second fluid can circulate around the outer periphery of the covering member 20. Specifically, both ends of the covering member 20 of the heat conductive member 100, 200, 300, 400, 500, 600 are joined to the inner surface of the outer cylinder 30. There are various joining methods, including fitting, as described above. If necessary, the joining points can be joined by welding or the like. As a result, the outer cylinder 30 is formed to circumferentially cover the outer periphery of the coating member 20, and the flow path for the second fluid is formed between the outer peripheral surface of the covering member 20 and the inner surface of the outer cylinder 30. The heat exchanger 1000 can be thus obtained.

When the inner cylinder and the on-off valve are further provided, the inner cylinder having the on-off valve can be inserted into the inner peripheral wall 16 of the honeycomb structure 10 and fitted by shrinkage fitting. The fitting of the inner cylinder into the inner peripheral wall 16 of the honeycomb structure 10 can be carried out by, in addition to the shrinkage fitting, fixing method based on fitting such clearance fitting, and interference fitting, as well as by brazing, welding, diffusion bonding, or the like, as described above.

Since the heat exchanger 1000 according to Embodiment 1 of the present invention includes the heat conductive member 100, 200, 300, 400, 500, 600 as described above, the heat recovery efficiency can be improved.

### Embodiment 2

### (1) Heat Conductive Member

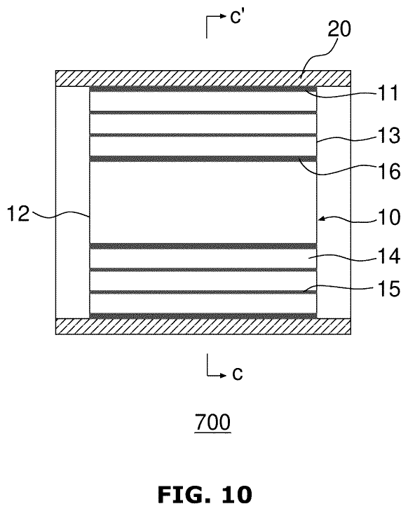

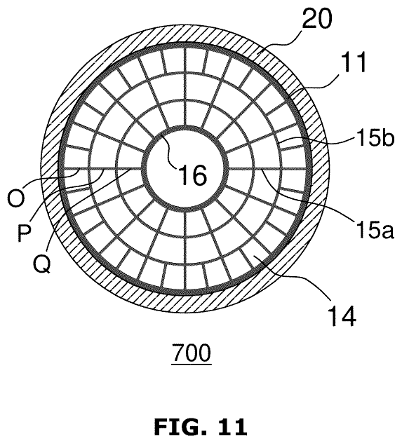

FIG. 10 is a cross-sectional view of a heat conductive member according to Embodiment 2 of the present invention, which is parallel to an axial direction (flow path direction) of a honeycomb structure. Also, FIG. 11 is a cross-sectional view taken along the line c-c′ in the heat conductive member shown in FIG. 10, that is, a cross-sectional view of the heat conductive member according to Embodiment 2 of the present invention, which is perpendicular to the axial direction of the honeycomb structure.

In FIGS. 10 and 11, the components indicated by the same reference numerals as in the above figures show the same components. Therefore, detailed descriptions of the same components will be omitted.

A heat conductive member 700 according to Embodiment 2 of the present invention includes: a honeycomb structure 10 including: an outer peripheral wall 11; an inner peripheral wall 16; and partition walls 15 arranged between the outer peripheral wall 11 and the inner peripheral wall 16, the partition walls 15 defining a plurality of cells 14 each extending from a first end face 12 to a second end face 13 to form a flow path for a first fluid. The heat conductive member 700 may optionally include a covering member 20 for covering an outer peripheral surface of the outer peripheral wall 11.

In the heat conductive member 700 having such a structure, heat exchange between the first fluid that can flow through the cells 14 and the second fluid that can flow over the outer periphery of the outer peripheral wall 11 is performed via the outer peripheral wall 11 of the honeycomb structure 10. Further, when the heat conductive member 700 includes the covering member 20, the heat exchange between the first fluid that can flow through the cells 14 and the second fluid that can flow over the outer periphery of the covering member 20 is performed via the outer peripheral wall 11 and the covering member 20.

The partition walls 15 forming the honeycomb structure 10 have a plurality of first partition walls 15a extending in a radial direction and a plurality of second cells 15b extending in a circumferential direction, in a cross section of the honeycomb structure 10 perpendicular to a flow path direction of the first fluid (that is, the cross section as shown in FIG. 11). The partition walls 15 (in particular the partition walls 15a) having such a structure can allow the heat of the first fluid to be transferred in the radial direction through the partition walls 15a, so that the heat of the first fluid can be efficiently transferred to the outside of the honeycomb structure 10.

In the honeycomb structure 10, the number of the cells 14 closest to the outer peripheral wall 11 in the circumferential direction is larger than that of the cells 14 closest to the inner peripheral wall 16 in the circumferential direction. For example, in the honeycomb structure 10 in the heat conductive member 700 as shown in FIG. 11, the number of the cells 14 closest to the outer peripheral wall 11 in the circumferential direction is 32, whereas the number of the cells 14 closest to the inner peripheral wall 16 in the circumferential direction is 16. The control of the number of the cells 14 in the circumferential direction in this manner can easily reduce the difference between the cell width on the inner peripheral wall 16 side and the cell width on the outer peripheral wall 11 side. As a result, the cells 14 on the outer peripheral wall 11 side can also perform heat recovery to the same extent as the cells 14 on the inner peripheral wall 16 side, so that the heat recovery efficiency of the honeycomb structure 10 can be improved as a whole.

The first partition walls 15a may have three or more portions that define three or more cells 14 in the radial direction, and the number of the cells 14 located on the outer peripheral wall 11 side in the circumferential direction may be equal to or larger than the number of the cells 14 located on the inner peripheral wall 16 side in the circumferential direction. For example, in the honeycomb structure 10 as shown in FIG. 11, the first partition walls 15a have three portions O to Q that define three cells 14 in the radial direction, and the number of the cells 14 defined by the partition walls 15 including the portion O in the circumferential direction is larger than the number of the cells 14 defined by the partition walls 15 including the portion P or Q in the circumferential direction. Also, the number of the cells 14 defined by the partition walls 15 including the portion P in the circumferential direction is the same as the number of the cells 14 defined by the partition walls 15 including the portion Q in the circumferential direction. The control of the number of the cells 14 in the circumferential direction in this manner can easily reduce the difference between the cell width on the central portion side and the cell width on the outer peripheral wall 11 side, so that the heat recovery efficiency in the cells 14 on the outer peripheral wall 11 side can be improved.

The cells 14 defined by the first partition walls 15a and the second partition walls 15b preferably have substantially the same cell width in the circumferential direction. Such a structure provides the same flow path resistance in the circumferential direction, so that the first fluid can be uniformly circulated in the circumferential direction.

The honeycomb structure 10 preferably has two or more regions having different numbers of the cells 14 in the circumferential direction. For example, the honeycomb structure 10 as shown in FIG. 11 has a region in which the number of the cells 14 defined by the partition walls 15 including the portion O in the circumferential direction is 32, and a region in which the number of the cells 14 defined by the partition walls 15 including the portion P or Q is 16. The control to have such regions can easily reduce the difference between the cell width on the inner peripheral wall 16 side and the cell width on the outer peripheral wall 11 side, so that the heat recovery efficiency can be improved.

The first partition walls 15a may linearly extend from the inner peripheral wall 16 to the outer peripheral wall 11, as shown in FIG. 11. The first partition walls 15a having such a structure provides linear heat transfer paths of the first partition walls 15a, so that the heat of the first fluid can be efficiently transferred to the outside of the honeycomb structure 10. On the other hand, if the first partition walls 15a do not linearly extend from the inner peripheral wall 16 to the outer peripheral wall 11, the heat transfer paths of the first partition walls 15a are curved (heat transfer is required via the second partition walls 15b), so that it will be difficult to efficiently transmit the heat of the first fluid to the outside of the honeycomb structure 10.

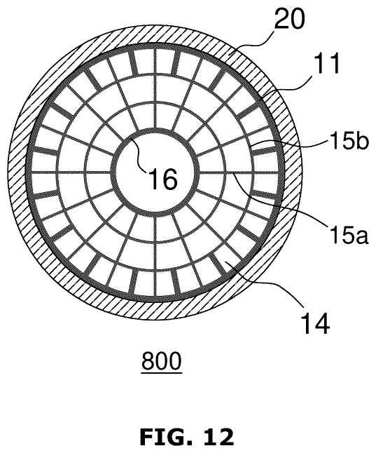

The partition walls 15 may include first partitions 15a having different thicknesses at adjacent portions in the circumferential direction. FIG. 12 shows a cross-sectional view of the heat conductive member having such a structure, which is perpendicular to the axial direction of the honeycomb structure. The heat conductive member 800 including the honeycomb structure 10 having the first partition walls 15a having such a structure can also easily reduce the difference between the cell width on the inner peripheral wall 16 side and the cell width on the outer peripheral wall 11 side, so that the heat recovery efficiency in the cells 14 on the outer peripheral wall 11 side can be improved.

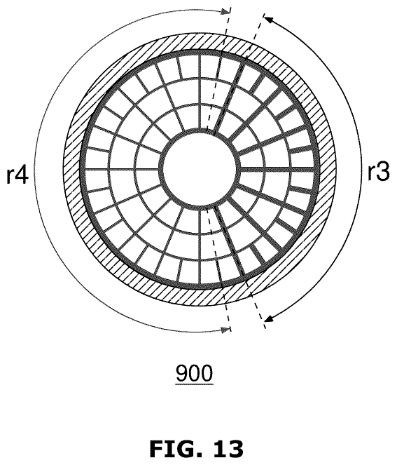

The honeycomb structure 10 may have two or more regions including the first partition walls 15a with different thicknesses in the circumferential direction. FIG. 13 shows a cross-sectional view of the heat conductive member having such a structure, which is perpendicular to the axial direction of the honeycomb structure. The honeycomb structure 10 in the heat conductive member 900 as shown in FIG. 13 has two regions r3 and r4 including the first partition walls 15a with different thicknesses in the circumferential direction. An actual heat exchanger may generate a portion where the heat of the first fluid is easily recovered and a portion where the heat of the first fluid is difficult to be recovered, depending on a position of a feed port or a discharge port of the second fluid flowing over the outer periphery of the outer peripheral wall 11 (or the covering member 20 if present). Therefore, the region r3 including the first partition walls 15a with a larger thickness is provided at the portion where the heat of the first fluid is easily recovered, and the region r4 including the first partition walls 15a with a smaller thickness is provided at the portion where the heat of the first fluid is difficult to be recovered, whereby the heat of the first fluid can be efficiently recovered.

The thickness of each of the outer peripheral wall 11, the inner peripheral walls 16 and the partition walls 15 (the first partition walls 15a and the second partition walls 15b) can be appropriately adjusted depending on the applications.

For example, the thicknesses of the outer peripheral wall 11, the second partition wall 15b, and the inner peripheral wall 16 may be the same as those of the honeycomb structure 10 of the heat conductive member according to Embodiment 1 of the present invention.

The thickness of the first partition walls 15a is preferably 0.05 to 1 mm, and more preferably 0.1 to 0.8 mm, and even more preferably 0.2 to 0.6 mm.

The heat conductive member 700, 800, 900 according to Embodiment 2 of the present invention can be produced by the same method as that of the heat conductive member 100, 200, 300, 400, 500, 600 according to Embodiment 1 of the present invention. In particular, the honeycomb structure 10 having a predetermined shape can control the shape and density of the cells 14, the number, length and thickness of the partition walls 14 (the second partition walls 15a and the second partition walls 15b), the shapes and thicknesses of the outer peripheral wall 11 and the inner peripheral wall 16, and the like, by selecting a die and a jig having an appropriate shape when producing the honeycomb formed body.

The heat conductive member 700, 800, 900 according to Embodiment 2 of the present invention includes the honeycomb structure 10 in which the number of the cells 14 closest to the outer peripheral wall 11 is larger than that of the cells 14 closest to the inner peripheral wall 16, so that the difference between the cell width on the central portion side and the cell width on the outer peripheral wall 11 side is smaller, and in the cells 14 on the outer peripheral wall 11 side, the heat recovery can be performed to the same extent as the cells 14 on the central portion side.

### (2) Heat Exchanger

The heat exchanger according to Embodiment 2 of the present invention includes the heat conductive member 700, 800, 900 as described above. A member(s) other than the heat conductive member 700, 800, 900 is/are not particularly limited, and a known member(s) may be used. For example, the heat exchanger according to Embodiment 2 of the present invention may include: the heat conductive member 700, 800, 900; and an outer cylinder (casing) at an interval on a radially outer side of the covering member 20 such that a second fluid can flow over the outer periphery of the covering member 20 of the heat conductive member 700, 800, 900.

The heat exchanger according to Embodiment 2 of the present invention has the same structure as that of the heat exchanger according to Embodiment 1 of the present invention as shown in FIGS. 8 and 9, with the exception that it has the heat conductive member 700, 800, 900 as described above, so a detailed description thereof will be omitted.

Since the heat exchanger according to Embodiment 2 of the present invention includes the heat conductive member 700, 800, 900 as described above, the heat recovery efficiency can be improved.

### EXAMPLES

Hereinafter, the present invention will be described in more detail with reference to Examples, but the present invention is not limited to these Examples.

### Example 1

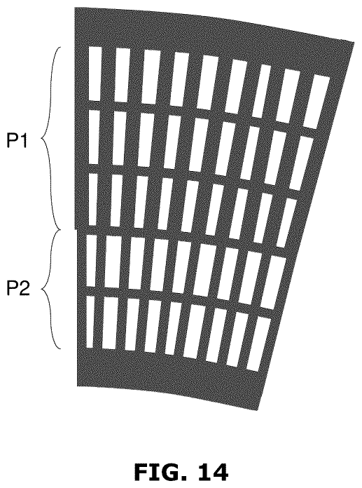

A green body containing SiC powder was extruded into a desired shape, dried, processed to have predetermined external dimensions, and impregnated with Si and fired to produce a hollow type honeycomb structure (cylindrical shape) having a hollow region in which the cross section perpendicular to the axial direction was circular. FIG. 14 shows a partially enlarged cross-sectional view of the produced honeycomb structure, which is perpendicular to the axial direction. The produced honeycomb structure set: the diameter (outer diameter) of the outer peripheral wall to 90 mm; the diameter of the inner peripheral wall to 60 mm; the length in the axial direction (flow path direction for the first fluid) to 50 mm; the thickness of each of the outer peripheral wall and the inner peripheral wall to 2 mm; the number of the first partition walls to 250; and the number of the second partition walls to 4. Further, the thickness of the first partition walls was such that the thickness of the portion P1 that defined three cells from the outer peripheral wall to the inner peripheral wall was 0.4 mm, and the thickness of the portion P2 that defined two cells from the inner peripheral wall to the outer peripheral wall was 0.3 mm, and the thickness of the second partition walls was 0.3 mm. In addition, the thermal conductivity (25° C.) of the honeycomb structure was set to 150 W/(m·K).

The above honeycomb structure was then subjected to shrinkage fitting into the covering member to produce a heat conductive member. As the covering member, a stainless steel tubular member (having a thickness of 1 mm) was used. The heat conductive member was then arranged in the outer cylinder (casing: a thickness of 1.5 mm) and both ends of the heat conductive member (covering member) were joined to the outer cylinder to produce a heat exchanger having the structure as illustrated in FIGS. 8 and 9.

### Example 2

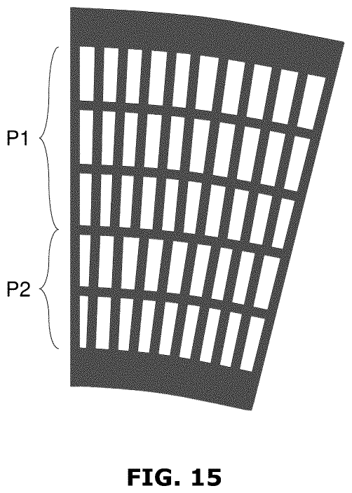

FIG. 15 shows a partially enlarged cross-sectional view of a honeycomb structure produced in Example 2, which is perpendicular to the axial direction. In Example 2, a honeycomb structure and a heat exchanger were produced under the same conditions as those of Example 1, with the except that the thickness of the first partition walls was all 0.3 mm, the number of the first partition walls at the portion P1 that defined three cells from the outer peripheral wall to the inner peripheral wall was changed to 300, the number of the first partition walls at the portion P2 that defined two cells from the inner peripheral wall to the outer peripheral wall was changed to 250.

### Comparative Example 1

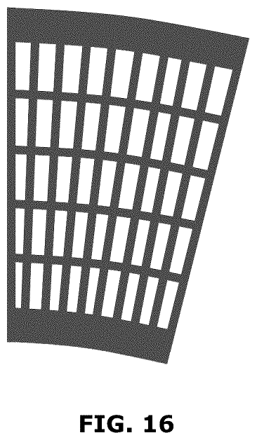

FIG. 16 shows a partially enlarged cross-sectional view of a honeycomb structure produced in Comparative Example 1, which is perpendicular to the axial direction. In Comparative Example 1, a honeycomb structure and a heat exchanger were produced under the same conditions as those Example 1, with the exception that the thicknesses of all the first partition walls were changed to 0.3 mm.

A heat exchange test was conducted on the heat exchangers produced in the above Examples and Comparative Example. The heat exchange test was conducted as follows.

Air (the first fluid) having a temperature (Tg1) of 400° C. flowed through each of the honeycomb structures of the heat exchangers at a flow rate (Mg) of 10 g/s. On the other hand, cooling water (the second fluid) at 40° C. was fed from the feed pipe for the second fluid at a flow rate (Mw) of 10 L/min, and the cooling water after heat exchange was recovered from the discharge pipe for the second fluid.

Immediately after passing air and cooling water through each heat exchanger for 5 minutes from the start of feed under the above conditions, a temperature (Tw1) of the cooling water at the inlet for the second fluid and a temperature (Tw2) of the cooling water at the outlet for the second fluid were measured to determine a recovered heat quantity Q:

Q(kW)=ΔT[K]×Cpw[J/(kg·K)]×Pw[kg/m3]×Mw[L/min]/(60×106), with:

ΔTw=Tw2−Tw1, and Cpw(specific heat of water)=4182 J/(kg·K), and Pw(water density)=997 kg/m3.

The above results are shown in Table 1

TABLE 1

| | | | Comparative |
|---|---|---|---|
| | Example 1 | Example 2 | Example 1 |
| Recovered Heat | 3.2 | 3.2 | 3.0 |
| Quantity | | | |
| (kW) | | | |

As shown in Table 1, each of Examples 1 and 2 had a higher recovered heat quantity than that of Comparative Example 1.

As can be seen from the above results, according to the present invention, it is possible to provide a heat conductive member and a heat exchanger which can improve a heat recovery efficiency.

### DESCRIPTION OF REFERENCE NUMERALS

10 honeycomb structure
11 outer peripheral wall
12 first end face
13 second end face
14 cell
15 partition wall
15a first partition wall
15b second partition
16 inner peripheral wall
20 covering member
30 outer cylinder
31 feed pipe
32 discharge pipe
100, 200, 300, 400, 500, 600, 700, 800, 900 heat conductive member
1000 heat exchanger

1. A heat conductive member, comprising a honeycomb structure comprising: an outer peripheral wall; and a plurality of partition walls arranged on an inner side of the outer peripheral wall, the partition walls defining a plurality of cells, each of the cells extending from a first end face to a second end face to form a flow path for a first fluid,
wherein in a cross section of the honeycomb structure perpendicular to a flow path direction for the first fluid, the partition walls comprise a plurality of first partition walls extending in a radial direction and a plurality of second partition walls extending in a circumferential direction, and
wherein at least a part of the first partition walls has a thickness of a portion that defines the cells closest to the outer peripheral wall larger than a thickness of a portion that defines the cells closest to a central portion.

2. The heat conductive member according to claim 1, wherein at least a part of the first partition walls has three or more portions that define three or more of the cells in the radial direction, and a thickness of the portions that define the cells located on the outer peripheral wall side is equal to or larger than that of the portions that define the cells located on the central portion side.

3. The heat conductive member according to claim 1, wherein the first partition walls linearly extend from the central portion to the outer peripheral wall.

4. The heat conductive member according to claim 1, wherein the cells have the same cell width in the circumferential direction.

5. The heat conductive member according to claim 1, wherein the honeycomb structure further comprises an inner peripheral wall, and the partition walls are arranged between the outer peripheral wall and the inner peripheral wall.

6. The heat conductive member according to claim 1, wherein the honeycomb structure comprises a Si—SiC material.

7. The heat conductive member according to claim 1, further comprising a covering member for covering the outer peripheral surface of the honeycomb structure.

8. A heat exchanger, comprising:
the heat conductive member according to claim 7; and
an outer cylinder arranged at an interval on a radially outer side of the covering member so that a second fluid can circulate over an outer periphery of the covering member.
